(19) United States
(12) Patent Application Publication
(10) Pub. No.: US 2022/0179706 A1
(43) Pub. Date: Jun. 9, 2022

(54) ADAPTIVE RESOURCE ALLOCATION SYSTEM AND METHOD FOR A TARGET APPLICATION EXECUTED IN AN INFORMATION HANDLING SYSTEM (IHS)

(71) Applicant: Dell Products, L.P., Round Rock, TX (US)

(72) Inventors: Farzad Khosrowpour, Pflugerville, TX (US); Fnu Jasleen, Austin, TX (US)

(73) Assignee: Dell Products, L.P., Round Rock, TX (US)

(21) Appl. No.: 17/114,164

(22) Filed: Dec. 7, 2020

(51) Int. Cl. G06F 9/50; G06F 11/34; G06N 20/00

(52) U.S. Cl. CPC G06F 9/5022; G06F 11/3409; G06F 2209/501; G06F 2209/5022; G06N 20/00

(57) ABSTRACT

Embodiments of systems and methods for managing performance optimization of applications executed by an Information Handling System (IHS) are described. In an illustrative, non-limiting embodiment, an IHS may include computer-executable instructions for determining one or more resource performance features of a resource used by the IHS using a first machine learning (ML) service, and determining one or more application performance features of a target application executed by the resource using a second ML service. Using the determined resource performance features and the application performance features, the instructions may generate a profile recommendation for the target application, and adjust one or more settings of the resource to optimize a performance of the target application executed by the resource.

### FIELD

The present disclosure relates generally to Information Handling Systems (IHSs), and more particularly, to an adaptive resource allocation system and method for a target application executed in an information handling system (IHS).

### BACKGROUND

As the value and use of information continue to increase, individuals and businesses seek additional ways to process and store it. One option available to users is Information Handling Systems (IHSs). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs can execute many different types of applications. The demand to improve the performance of applications is continually increasing, and to meet this need, optimization engines have been developed to improve application performance by dynamically adjusting IHS settings. However, as the inventors hereof have recognized a need exists to understand the environment in which applications are operating; and therefore, the problem of optimal utilization of resources to improve responsiveness of applications should be addressed. It is with these issues in mind that embodiments of the present disclosure are disclosed herein.

### SUMMARY

According to one embodiment, an Information Handling System (IHS) includes computer-executable instructions for determining one or more resource performance features of a resource used by the IHS using a first machine learning (ML) service, and determining one or more application performance features of a target application executed by the resource using a second ML service. Using the determined resource performance features and the application performance features, the instructions may generate a profile recommendation for the target application, and adjust one or more settings of the resource to optimize a performance of the target application executed by the resource.

According to another embodiment, an IHS-based method includes determining one or more resource performance features of a resource used by the IHS using a first machine learning (ML) service, and determining one or more application performance features of a target application executed by the resource using a second ML service. The method further includes using the determined resource performance features and the application performance features to generate a profile recommendation for the target application, and adjusting one or more settings of the resource to optimize a performance of the target application executed by the resource.

According to yet another embodiment, a memory storage device of an IHS may include instructions for determining one or more resource performance features of a resource used by the IHS using a first machine learning (ML) service, and determining one or more application performance features of a target application executed by the resource using a second ML service. The instructions stored in the memory device further uses the determined resource performance features and the application performance features to generate a profile recommendation for the target application, and adjusting one or more settings of the resource to optimize a performance of the target application executed by the resource.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram an example of an Information Handling System (IHS) configured to manage performance optimization of applications according to one embodiment of the present disclosure.

FIG. 2 is a block diagram illustrating an example of software system produced by IHS for managing the performance optimization of applications according to one embodiment of the present disclosure.

FIG. 3 is a timing diagram illustrating an example sequence of actions that may be taken by application performance optimizer to optimize the performance of several applications executed on IHS according to one embodiment of the present disclosure.

FIG. 4 illustrates an example method that may be performed by the software system to optimize a target application according to one embodiment of the present disclosure.

### DETAILED DESCRIPTION

Embodiments of the present disclosure provide an adaptive resource allocation system and method for a target application executed in an information handling system (IHS) in which one or more resources of the IHS used to support the execution of the target application may be optimized using a resource machine learning (ML) service. The resource ML service derives one or more resource performance related features that may be combined with application performance related features derived by an application ML service to adjust or otherwise adapt the resources to execute the target application at an optimal performance level. The application ML service provides an understanding of how the target application may be used in the IHS, while the resource ML services provides an understanding of the environment in which applications are operating, thus providing a means by which the resources used to support the target application may be optimized to improve the performance (e.g., responsiveness) of the target application.

Conventional techniques for IHS optimization have involved workload and thermal oriented optimization of central processing unit (CPU) performance, such as a DYNAMIC THERMAL TUNING CPU optimization feature provided by INTEL. This optimization feature, however, provides no context of applications or how those applications may be use any resources (e.g., CPU, GPU, storage, etc.) of the IHS. Rather, it merely performs an optimization based on the workload on the system, but fails to differentiate among the myriad of applications (e.g., word processor, spreadsheet, multi-media content processor, etc.) that may be executed by the IHS. Another conventional optimization technique involves those that differentiate among foreground and background applications, such as the BAM scheduler provided by MICROSOFT that gives more quality of service to the foreground application by distributing it to the proper cores. However, it does not perform any kind of workload type detection of the resources used to support the foreground application, or consider any system variables used to support that foreground application.

As will be described in detail herein below, the adaptive resource allocation system and method according to the teachings of the present disclosure provide a solution to these, as well as other problems by reallocating resources adaptively via predicting the resource utilization at a system and an application level by collecting and processing system and process variables. In some cases, the system and method can lead to 7-10 percent (%) improvement in the response time by manipulation of software with no substantial change in the hardware used to support the application.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

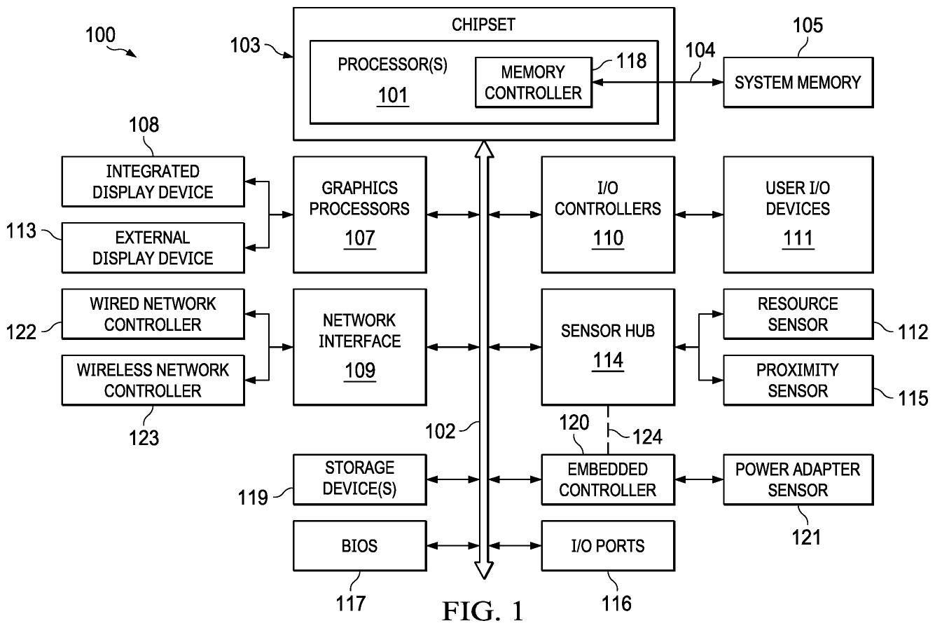

FIG. 1 is a block diagram illustrating components of IHS 100 configured to manage performance optimization of applications. As shown, IHS 100 includes one or more processors 101, such as a Central Processing Unit (CPU), that execute code retrieved from system memory 105. Although IHS 100 is illustrated with a single processor 101, other embodiments may include two or more processors, that may each be configured identically, or to provide specialized processing operations. Processor 101 may include any processor capable of executing program instructions, such as an Intel Pentium™ series processor or any general-purpose or embedded processors implementing any of a variety of Instruction Set Architectures (ISAs), such as the x86, POWERPC®, ARM®, SPARC®, or MIPS° ISAs, or any other suitable ISA.

In the embodiment of FIG. 1, processor 101 includes an integrated memory controller 118 that may be implemented directly within the circuitry of processor 101, or memory controller 118 may be a separate integrated circuit that is located on the same die as processor 101. Memory controller 118 may be configured to manage the transfer of data to and from the system memory 105 of IHS 100 via high-speed memory interface 104. System memory 105 that is coupled to processor 101 provides processor 101 with a high-speed memory that may be used in the execution of computer program instructions by processor 101.

Accordingly, system memory 105 may include memory components, such as static RAM (SRAM), dynamic RAM (DRAM), NAND Flash memory, suitable for supporting high-speed memory operations by the processor 101. In certain embodiments, system memory 105 may combine both persistent, non-volatile memory and volatile memory. In certain embodiments, system memory 105 may include multiple removable memory modules.

IHS 100 utilizes chipset 103 that may include one or more integrated circuits that are connected to processor 101. In the embodiment of FIG. 1, processor 101 is depicted as a component of chipset 103. In other embodiments, all of chipset 103, or portions of chipset 103 may be implemented directly within the integrated circuitry of the processor 101. Chipset 103 provides processor(s) 101 with access to a variety of resources accessible via bus 102. In IHS 100, bus 102 is illustrated as a single element. Various embodiments may utilize any number of separate buses to provide the illustrated pathways served by bus 102.

In various embodiments, IHS 100 may include one or more I/O ports 116 that may support removable couplings with various types of external devices and systems, including removable couplings with peripheral devices that may be configured for operation by a particular user of IHS 100. For instance, I/O 116 ports may include USB (Universal Serial Bus) ports, by which a variety of external devices may be coupled to IHS 100. In addition to or instead of USB ports, I/O ports 116 may include various types of physical I/O ports that are accessible to a user via the enclosure of the IHS 100.

In certain embodiments, chipset 103 may additionally utilize one or more I/O controllers 110 that may each support the operation of hardware components such as user I/O devices 111 that may include peripheral components that are physically coupled to I/O port 116 and/or peripheral components that are wirelessly coupled to IHS 100 via network interface 109. In various implementations, I/O controller 110 may support the operation of one or more user I/O devices 111 such as a keyboard, mouse, touchpad, touchscreen, microphone, speakers, camera and other input and output devices that may be coupled to IHS 100. User I/O devices 111 may interface with an I/O controller 110 through wired or wireless couplings supported by IHS 100. In some cases, I/O controllers 110 may support configurable operation of supported peripheral devices, such as user I/O devices 111.

As illustrated, a variety of additional resources may be coupled to the processor(s) 101 of the IHS 100 through the chipset 103. For instance, chipset 103 may be coupled to network interface 109 that may support different types of network connectivity. IHS 100 may also include one or more Network Interface Controllers (NICs) 122 and 123, each of which may implement the hardware required for communicating via a specific networking technology, such as Wi-Fi, BLUETOOTH, Ethernet and mobile cellular networks (e.g., CDMA, TDMA, LTE). Network interface 109 may support network connections by wired network controllers 122 and wireless network controllers 123. Each network controller 122 and 123 may be coupled via various buses to chipset 103 to support different types of network connectivity, such as the network connectivity utilized by IHS 100.

Chipset 103 may also provide access to one or more display device(s) 108 and 113 via graphics processor 107. Graphics processor 107 may be included within a video card, graphics card or within an embedded controller installed within IHS 100. Additionally, or alternatively, graphics processor 107 may be integrated within processor 101, such as a component of a system-on-chip (SoC). Graphics processor 107 may generate display information and provide the generated information to one or more display device(s) 108 and 113, coupled to IHS 100.

One or more display devices 108 and 113 coupled to IHS 100 may utilize LCD, LED, OLED, or other display technologies. Each display device 108 and 113 may be capable of receiving touch inputs such as via a touch controller that may be an embedded component of the display device 108 and 113 or graphics processor 107, or it may be a separate component of IHS 100 accessed via bus 102. In some cases, power to graphics processor 107, integrated display device 108 and/or external display 113 may be turned off, or configured to operate at minimal power levels, in response to IHS 100 entering a low-power state (e.g., standby).

As illustrated, IHS 100 may support an integrated display device 108, such as a display integrated into a laptop, tablet, 2-in-1 convertible device, or mobile device. IHS 100 may also support use of one or more external displays 113, such as external monitors that may be coupled to IHS 100 via various types of couplings, such as by connecting a cable from the external display 113 to external I/O port 116 of the IHS 100. In certain scenarios, the operation of integrated displays 108 and external displays 113 may be configured for a particular user. For instance, a particular user may prefer specific brightness settings that may vary the display brightness based on time of day and ambient lighting conditions.

Chipset 103 also provides processor 101 with access to one or more storage devices 119. In various embodiments, storage device 119 may be integral to IHS 100 or may be external to IHS 100. In certain embodiments, storage device 119 may be accessed via a storage controller that may be an integrated component of the storage device. Storage device 119 may be implemented using any memory technology allowing IHS 100 to store and retrieve data. For instance, storage device 119 may be a magnetic hard disk storage drive or a solid-state storage drive. In certain embodiments, storage device 119 may be a system of storage devices, such as a cloud system or enterprise data management system that is accessible via network interface 109.

As illustrated, IHS 100 also includes Basic Input/Output System (BIOS) 117 that may be stored in a non-volatile memory accessible by chipset 103 via bus 102. Upon powering or restarting IHS 100, processor(s) 101 may utilize BIOS 117 instructions to initialize and test hardware components coupled to the IHS 100. BIOS 117 instructions may also load an operating system (OS) (e.g., WINDOWS, MACOS, iOS, ANDROID, LINUX, etc.) for use by IHS 100.

BIOS 117 provides an abstraction layer that allows the operating system to interface with the hardware components of the IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 100 embodiments may utilize sensor hub 114 capable of sampling and/or collecting data from a variety of sensors. For instance, sensor hub 114 may utilize hardware resource sensor(s) 112, which may include electrical current or voltage sensors, and that are capable of determining the power consumption of various components (e.g., resources) of IHS 100 (e.g., CPU 101, GPU 107, system memory 105, network resources (e.g., network interface 107, wired network controller 122, wireless network controller 123), platform resources (e.g., power supplies, cooling systems, batteries) etc.). In certain embodiments, sensor hub 114 may also include capabilities for determining a location and movement of IHS 100 based on triangulation of network signal information and/or based on information accessible via the OS or a location subsystem, such as a GPS module.

In some embodiments, sensor hub 114 may support proximity sensor(s) 115, including optical, infrared, and/or sonar sensors, which may be configured to provide an indication of a user's presence near IHS 100, absence from IHS 100, and/or distance from IHS 100 (e.g., near-field, mid-field, or far-field).

In certain embodiments, sensor hub 114 may be an independent microcontroller or other logic unit that is coupled to the motherboard of IHS 100. Sensor hub 114 may be a component of an integrated system-on-chip incorporated into processor 101, and it may communicate with chipset 103 via a bus connection such as an Inter-Integrated Circuit (I²C) bus or other suitable type of bus connection. Sensor hub 114 may also utilize an I²C bus for communicating with various sensors supported by IHS 100.

As illustrated, IHS 100 may utilize embedded controller (EC) 120, which may be a motherboard component of IHS 100 and may include one or more logic units. In certain embodiments, EC 120 may operate from a separate power plane from the main processors 101 and thus the OS operations of IHS 100. Firmware instructions utilized by EC 120 may be used to operate a secure execution system that may include operations for providing various core functions of IHS 100, such as power management, management of operating modes in which IHS 100 may be physically configured and support for certain integrated I/O functions.

EC 120 may also implement operations for interfacing with power adapter sensor 121 in managing power for IHS 100. These operations may be utilized to determine the power status of IHS 100, such as whether IHS 100 is operating from battery power or is plugged into an AC power source (e.g., whether the IHS is operating in AC-only mode, DC-only mode, or AC+DC mode). In some embodiments, EC 120 and sensor hub 114 may communicate via an out-of-band signaling pathway or bus 124.

In various embodiments, IHS 100 may not include each of the components shown in FIG. 1. Additionally, or alternatively, IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 101 as an SoC.

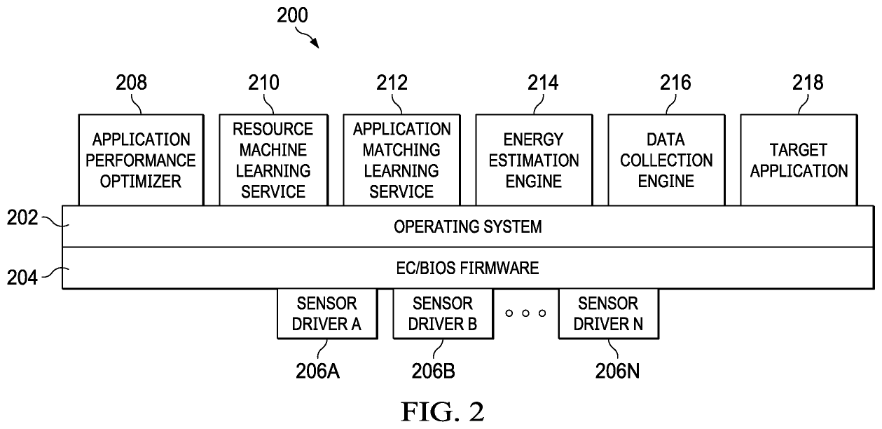

FIG. 2 is a block diagram illustrating an example of software system 200 produced by IHS 100 for managing the performance optimization of applications. In some embodiments, each element of software system 200 may be provided by IHS 100 through the execution of program instructions by one or more logic components (e.g., CPU 100, BIOS 117, EC 120, etc.) stored in memory (e.g., system memory 105), storage device(s) 119, and/or firmware 117, 120. As shown, software system 200 includes an application performance optimizer 208 configured to manage the performance optimization of a target application 218. Although only one target application 218 is shown herein, it should be understood that application performance optimizer 208 may be configured to optimize the performance of any number of target applications that may be executed on IHS 100.

In one embodiment, application performance optimizer 208 may include features, or form a part of, the DELL PRECISION OPTIMIZER. Examples of a suitable target application 218 whose performance may be optimized includes resource-intensive applications, such as MICROSOFT POWERPOINT, MICROSOFT EXCEL, MICROSOFT WORD, ADOBE ILLUSTRATOR, ADOBE AFTER EFFECTS, ADOBE MEDIA ENCODER, ADOBE PHOTOSHOP, ADOBE PREMIER, AUTODESK AUTOCAD, AVID MEDIA COMPOSER, ANSYS FLUENT, ANSYS WORKBENCH, SONAR CAKEWALK, and the like; as well as less resource-intensive applications, such as media players, web browsers, document processors, email clients, etc.

Both application performance optimizer 208 and target application 218 are executed by an OS 202, which is turn supported by EC/BIOS instructions/firmware 204. EC/BIOS firmware 204 is in communications with, and configured to receive data collected by, one or more sensor modules or drivers 206₁-206_{N}, which may abstract and/or interface with hardware resource sensor 112, proximity sensor 115, and power adapter sensor 121, for example.

In various embodiments, software system 200 also includes an energy estimation engine 214, such as the MICROSOFT E3 engine, which is configured to provide energy usage data broken down by applications, services, tasks, and/or hardware in an IHS. In some cases, energy estimation engine 214 may use software and/or hardware sensors configured to determine, for example, whether target application 218 is being executed in the foreground or in the background (e.g., minimized, hidden, etc.) of the IHS's graphical user interface (GUI).

Data collection engine 216 may include any data collection service or process, such as, for example, the DELL DATA VAULT configured as a part of the DELL SUPPORT CENTER that collects information on system health, performance, and environment. In some cases, data collection engine 216 may receive and maintain a database or table that includes information related to IHS hardware utilization (e.g., by application, by thread, by hardware resource, etc.), power source (e.g., AC-plus-DC, AC-only, or DC-only), and the like.

In operation, application performance optimizer 208 may use a resource loading machine learning (ML) service 210 and an application utilization ML service 212 to improve the performance of target application 218.

In general, resource machine learning service 210 performs a machine learning process to derive certain resource performance features associated with various resources in IHS 100. In one embodiment, resources for which resource performance features can be derived includes one or more central processing units (CPUs) 101 of the IHS 100, one or more graphical processing units (GPUs) 107 configured in IHS 100, one or more storage devices 119 configured in IHS 100, one or more network resources configured in IHS 100, one or more platform resources, as described above. In other embodiments, resource machine learning service 210 may perform the ML process for other resources not explicitly cited herein that may have an impact upon the performance of target application 218. Resource machine learning service 210 monitors characteristics (e.g., telemetry data, warning messages, error messages, etc.) of each resource to characterize the workload on each resource. For example, resource machine learning service 210 may obtain data from energy estimation engine 214, data collection engine 216, and/or directly from sensors 206₁-206_{N} configured in IHS 100. Once resource machine learning service 210 has collected a sufficient amount of data over a period of time, it may then process the collected data using statistical descriptors to extract the resource performance features of the relevant resources.

Resource machine learning service 210 may monitor resource usage over time to estimate resource usage with respect to various aspects, such as the execution of certain applications that may affect resource usage, actions (e.g., opening a certain type of file, initiating a FTP transfer session, calling another process on IHS 100 to perform a certain service, etc.) performed by those applications that may cause resource usage to increase, a recurring time period of day (e.g., morning, afternoon, evening, etc.), or other user-based behavior in which those actions occur. In a particular example, resource machine learning service 210 may collect data associated with a user that starts a certain application each morning at 8:00 am, and with that application performs file operations that yield a certain level of loading on the storage resource of IHS 100. Later at 8:30 am, the user performs several computational tasks using that application, thus loading the CPU resource over a period of several hours. Data that is collected with regard to this behavior may be used by resource machine learning service 210 to extract those resource performance features associated with the storage and CPU usage, and the time periods in which the storage and CPU is used. Although only resource machine learning service 210 is described as a single component, it should be appreciated that multiple resource machine learning services 210 may function concurrently to share ML hints with one another and with ML hints from application learning service 212. Additionally, it is contemplated that embodiments of the present disclosure may involve ML hints share with other machine learning algorithms other than resource machine learning services 210, or application machine learning service 212 without departing from the spirit and scope of the present disclosure.

Application machine learning service 212 performs a machine learning process to derive certain application performance features associated with target application 218 executed by IHS 100. Target application 218 may be any type for which optimization of its performance is desired. In one embodiment, IHS 100 may include a user-editable list, such as one included in a configuration file of application performance optimizer 208, of multiple target applications 218 whose performance is to be optimized by application performance optimizer 208. In another embodiment, application machine learning service 212, or other process included in system 200, may include executable code for providing a ML process to derive which applications are to be optimized by application performance optimizer 208.

Application machine learning service 212 monitors data associated with the operation of target application 218 to characterize its resource utilization. For example, application machine learning service 212 may obtain telemetry data from energy estimation engine 214, data collection engine 216, and/or directly from sensors 206₁-206_{N} configured in IHS 100 to determine one or more performance features associated with target application 218. Once application machine learning service 212 has collected characteristics over a period of time, it may then process the collected data using statistical descriptors to extract the application performance features of target application 218. For example, application machine learning service 212 may monitor target application 218 over time to estimate its resource usage with respect to various aspects, such as which actions performed by target application 218 cause certain resources to encounter loading, events occurring on IHS 100 that causes target application 218 to require a relatively high level of resource usage, and a time period of day in which these actions are encountered. Once application machine learning service 212 has collected characteristics over a period of time, it may then process the collected data using statistical descriptors to extract the application performance features associated with target application 218.

Both or either of resource machine learning service 210 and application machine learning service 212 may use a machine learning algorithm such as, for example, a Bayesian algorithm, a Linear Regression algorithm, a Decision Tree algorithm, a Random Forest algorithm, a Neural Network algorithm, or the like.

Application performance optimizer 208 receives resource performance features of resources derived by resource machine learning service 210 and application performance features of target application 218 derived by application machine learning service 212, and evaluates the performance features of each against a trained ML model to obtain a profile recommendation. Using the profile recommendation, application performance optimizer 208 adjusts (e.g., adapts) the resources to optimize the performance of target application 218. In one embodiment, application performance optimizer 208 combines the performance features of resources derived by resource machine learning service 210 and performance features of target application 218 derived by application machine learning service 212 using a ML hinting process. Hinting generally refers to a process of ML whereby features derived by a first ML process may be shared with another ML process to derive additional features above and beyond those features that would otherwise be individually derived. In the present case, application performance optimizer 208 combines the resource performance features of resources derived by resource machine learning service 210, and application performance features of target application 218 derived by application machine learning service 212 in a manner so that additional performance features can be derived. These additional performance features can then be compared against trained ML models provided by each of resource machine learning service 210 and application machine learning service 212 to obtain a profile recommendation that can be used to optimize the resources for executing target application 218.

Embodiments of the present disclosure may provide advantages over conventional ML techniques in that application machine learning service 212 is separate and distinct from resource machine learning service 210; that is, they operate independently of one another. For example, because resource machine learning service 210 generates a ML model of resources used in IHS 100 separately from application machine learning service 212, the generated resource ML model can be reused for each of multiple target applications 218 optimized by the system 200, thus saving processing and storage resources that would otherwise be required for each target application 218 optimized by system 200. Additionally, because application machine learning service 212 generates an application ML model of target application 218 that is generally independent of the resources it uses, the application machine learning service 212 may glean additional feature information about how target application 218 operates under different circumstances without incurring noisy effects of resource usage that would otherwise obfuscate the gleaned feature information.

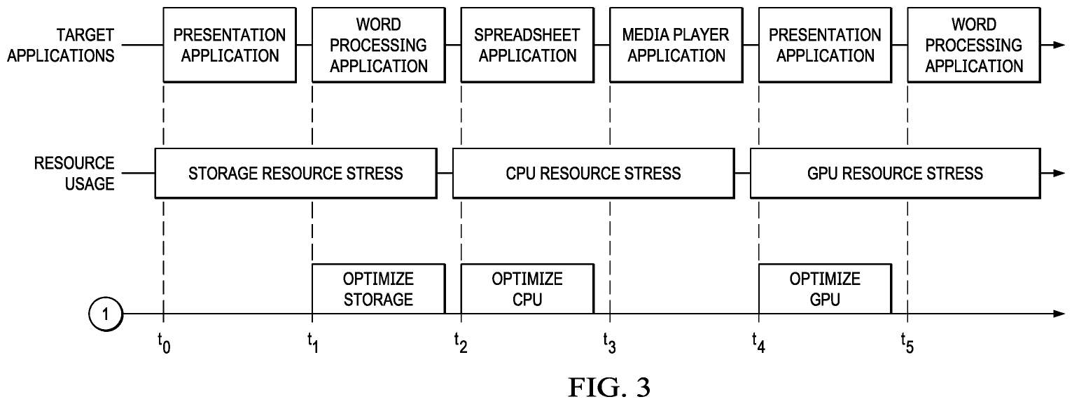

FIG. 3 is a timing diagram illustrating an example sequence of actions that may be taken by application performance optimizer 208 to optimize the performance of several applications executed on IHS 100 according to one embodiment of the present disclosure. In particular, the timing diagram shows how application performance optimizer 208 can be used even in the presence of a capricious computing environment where multiple alternative applications may be intermittently used over the course of a relatively short period of time. While the particular example timing diagram illustrates how CPU, GPU, and storage resources may be optimized, it should be appreciated that other types of resources, such as network resources, and platform resources, may also be optimized according to embodiments of the present disclosure.

At time t₀, a presentation target application 218 (e.g., MICROSOFT POWERPOINT) is launched while the storage resource is currently exhibiting stress (e.g., a relatively high level of usage).

But since the presentation target application 218 primarily uses GPU resources, no action is taken by application performance optimizer 208 to optimize the resources used to execute the presentation target application 218. That is, application performance optimizer 208 may only optimize a resource when that resource exceeds a specified threshold level indicative of stress on that resource. At time t₁ however, a word processing target application 218 is launched while the storage resource is still exhibiting stress. Additionally, the word processing target application 218 is also using a large amount of storage resources, and therefore, application performance optimizer 208 optimizes the storage resource to improve the performance of the word processing target application 218 on IHS 100.

At a later point in time t₂, the storage resource is no longer exhibiting stress, but the CPU resource is. As such, when a spreadsheet target application (e.g., MICROSOFT EXCEL) is launched and begins to consume a relatively large level of CPU power, application performance optimizer 208 may then optimize the CPU resource to optimize the performance of the spreadsheet target application. Later on at time t₃, the spreadsheet target application is no longer running when a media player target application is launched. Nevertheless, due to the fact that the media player target application may primarily be using GPU resources, and only the CPU resources are currently under stress, no action is taken by application performance optimizer 208.

At time t₄, the CPU resource is no longer exhibiting stress, but the GPU resource is. As such, when the presentation target application again begins to consume a relatively large amount of GPU resources while the GPU resource is under stress, then application performance optimizer 208 may optimize the GPU resource to optimize the performance of the presentation target application. Later on at time t₅, the presentation target application is no longer running when the word processing application is again launched. Due to the fact that the word processing target application may primarily be using CPU resources, and only the GPU resources are currently under stress, no action is taken by application performance optimizer 208.

Thus as can be seen by the foregoing description, application performance optimizer 208 may be configured to optimize resources in IHS 100 only when those resources used by the target application 218 are actively under stress. In this manner, application performance optimizer 208 may become involved with resource optimization only when it would be beneficial to do so, thus limiting the amount and level of superfluous actions that may be performed by application performance optimizer 208.

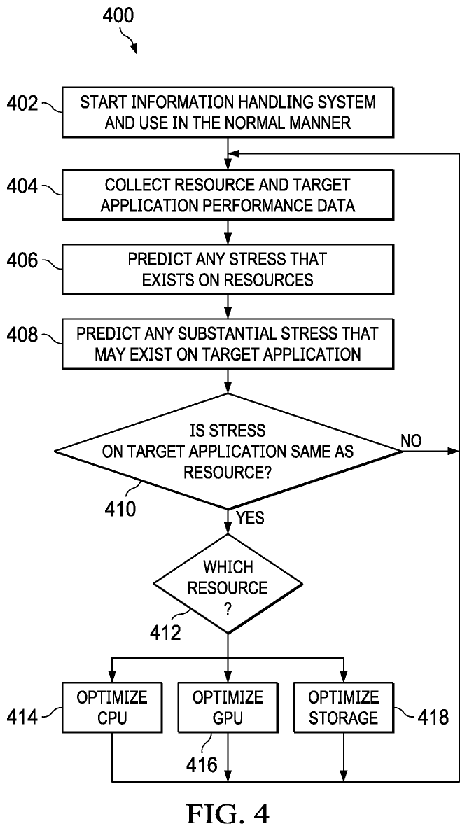

FIG. 4 illustrates an example method 400 that may be performed by system 200 to optimize a target application according to one embodiment of the present disclosure. In some embodiments, method 400 may be executed, at least in part, by operation of application performance optimizer 208, resource machine learning service 210, and/or application machine learning service 212 of system 200. As noted above, application machine learning service 212 may monitor target application 218, gather data for a predetermined period of time, and use the gathered data to characterize its behavior under varying workloads exhibited on the resources. In various implementations, method 400 may be used to adaptively manage the various characterizations, learning, and/or optimization processes performed by application performance optimizer 208 by taking into account information received by energy estimation engine 214, data collection engine 216, and sensors 206₁-206_{N}.

At step 402, the IHS is started and used in a normal manner. During its normal use, resource machine learning service 210 and application machine learning service 212 collect data associated with the operation of resources (e.g., CPU, GPU, storage, etc.) and the target application to be optimized, respectively, at step 404. For example, resource machine learning service 210 and application machine learning service 212 may collect data every 30 minute at an ongoing basis over a period of time, such as a few days to a few weeks, until sufficient data may be obtained in which one or more performance features of the resources of IHS and target application may be derived.

At step 406, resource machine learning service 210 predicts any stress (e.g., substantial loading or usage) that may exist on the resources. Likewise, at step 408, application machine learning service 212 predicts any stress that may exist on the target application. For example, resource machine learning service 210 may predict that, due to the time of day and the type of applications or other processes running on the IHS, stress will likely exist on a certain resource. Additionally, application machine learning service 212 may predict that, due to the actions currently being performed by the target application, it will likely be using a relatively large amount of another certain resource. Therefore at step 410, the method 400 determines whether the stress likely to exist on that certain resource is the same resource predicted to be exhibiting a large degree by the target application. If not, processing continues at step 404 to continue gathering data from the resources and target application for enhance accuracy. If, however, the predicted usage of the target application is based on the same resource that is predicted to exhibit substantial loading, processing continues at step 412.

At step 412, the method 400 determines which resource is exhibiting a substantial amount of stress. If the CPU resource is exhibiting a substantial amount of stress, processing continues at step 414. However, if the GPU resource is exhibiting a substantial amount of stress, processing continues at step 416, and if the storage resource is exhibiting a substantial amount of stress, processing continues at step 418.

At step 414, the method 400 optimizes the CPU resource to enhance a performance level of the target application. In one embodiment, the method 400 may optimize the CPU resource by adjusting a power level applied to the CPU. In another embodiment, the method 400 may optimize the CPU resource by adjusting an overclocking or underclocking level of the CPU. Overclocking is a process whereby the clock speed of a CPU is increased in order to yield a corresponding increase in instruction processing rate by the CPU. Conversely, underclocking is a process whereby the clock speed of a CPU is decreased in order to yield a corresponding decrease in instruction processing rate by the CPU. So even if the CPU has been previously underclocked at a first level, the performance of the CPU may still be enhanced by decreasing a level of underclocking provided to the CPU to increase its performance.

At step 416, the method 400 optimizes the GPU resource to enhance the performance level of the target application. The performance of the GPU resource may be enhanced in any suitable manner. In one embodiment, the GPU resource may be enhanced by adjusting one or more of a frame rate, often rated in frames per second (FPS), a refresh rate, or a computational frame rate of the GPU. The frame rate generally refers to how many images are stored or generated every second by the GPU resource. The refresh rate (vertical scan rate), on the other hand, refers to the number of times per second that the GPU resource displays a new image. The computational frame rate generally refers to a ratio of sequential images of a video image that are computationally processed by the GPU resource. Each of these aspects of the GPU resource may be adjusted to improve a performance level of the GPU resource. For example, reducing either of the frame rate, refresh rate, and/or computational frame rate may be useful for alleviating a processing load placed upon the GPU resource so that the additional processing load incurred by the target application may be performed more efficiently.

At step 418, the method 400 optimizes the storage resource to enhance the performance level of the target application. The performance of the storage resource may be enhanced by any one or several storage enhancement techniques. In one embodiment, the storage resource may be enhanced by adjusting a write optimized setting or a read optimized setting of the storage unit. For example, if application machine learning service 212 estimates that the target application is conducting an extended write operation to the storage resource, such as via a FTP download process, the method 400 may adjust the storage resource to have a write optimized setting. In another embodiment, the storage resource may be adjusted by increasing its cache size in RAM memory to handle the additional load incurred by the storage resource. Other techniques for enhancing the performance of the storage resource exist.

When either of steps 414, 416, or 418 have been completed, processing reverts to step 404 in which the method 400 continues collecting data from the IHS for further enhancement of the ML models generated by both the resource machine learning service 210 and application machine learning service 212. Nevertheless, when use of the method 400 is no longer needed or desired, the method 400 ends.

Although FIG. 4 describes one example of a process that may be performed by IHS 100 for enhancing a performance level of a target application, the features of the disclosed process may be embodied in other specific forms without deviating from the spirit and scope of the present disclosure. For example, step 408 may be performed prior to step 406, or alternatively, steps 406 and 408 may be performed concurrently. As another example, the method 400 may perform additional, fewer, or different operations than those operations as described in the present example. As yet another example, the steps of the process described herein may be performed by a computing system other than application performance optimizer 208, resource machine learning service 210, and/or application machine learning service 212, such as by an embedded controller, such as EC (BIOS) FIRMWARE 204 as described above with reference to FIG. 2. As yet another example, the steps of the process described herein may be performed to optimize CPU, GPU, and storage resources, it should be appreciated that other types of resources, such as network resources, and platform resources, may also be optimized according to embodiments of the present disclosure.

As can be seen from the foregoing description, resource machine learning service 210 and application machine learning service 212 may be independently operated for continual enhancement of the accuracy of ML models generated for both the target application as well as the resources used to support the target application on the IHS. Additionally, as data is continually collected over time, new performance features may be derived and used for further enhancement of the performance of the target application. Additionally, because the method 400 only optimizes resources when those resources used by the target application 218 are actively under stress, any unnecessary actions of enhancing performance of resources can be reduced or eliminated in some embodiments.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
at least one processor; and
at least one memory coupled to the at least one processor, the at least one memory having program instructions stored thereon that, upon execution by the at least one processor, cause the IHS to:
determine one or more resource performance features of a resource used by the IHS using a first machine learning (ML) service;
determine one or more application performance features of a target application executed by the resource using a second ML service;
generate a profile recommendation for the target application according to the determined resource performance features and the application performance features; and
adjust one or more settings of the resource to optimize a performance of the target application executed by the resource.

2. The IHS of claim 1, wherein the instructions are further executed to generate the profile recommendation by combining the resource performance features with the application performance features using a ML hinting technique.

3. The IHS of claim 1, wherein the instructions are further executed to execute the first ML service separately and distinctly from how the second ML service is executed.

4. The IHS of claim 1, wherein the instructions are further executed to adjust the settings of the resource only when a loading of the resource exceeds a specified threshold level.

5. The IHS of claim 1, wherein the resource comprises the processor, and wherein the instructions are further executed to optimize the target application by adjusting at least one of a power operating level of the processor, a level of overclocking of the processor, or a level of underclocking of the processor.

6. The IHS of claim 1, wherein the resource comprises a graphics processing unit (GPU) of the IHS, and wherein the instructions are further executed to optimize the target application by adjusting at least one of a frame rate, a refresh rate, or a computational frame rate of the GPU.

7. The IHS of claim 1, wherein the resource comprises a storage device of the IHS, and wherein the instructions are further executed to optimize the target application by adjusting at least one of a write optimized setting, a read optimized setting, or a cache level of the storage device.

8. The IHS of claim 1, wherein the resource performance feature comprises one or more other applications that affect the loading of the resource, wherein the instructions are further executed to optimize the target application by adjusting a priority of the other applications executed on the resource.

9. The IHS of claim 1, wherein the application performance feature comprises detecting a particular operation performed by the target application, wherein the instructions are further executed to optimize the target application by adjusting a setting of the resource according to the detected operation.

10. The IHS of claim 1, wherein the application performance feature comprises a location of the IHS, wherein the instructions are further executed to optimize the target application by adjusting a setting of the resource according to the location of the IHS.

11. A method comprising:
determining, using instructions stored in at least one memory and executed by at least one processor, one or more resource performance features of a resource used by the IHS using a first machine learning (ML) service;
determining, using the instructions, one or more application performance features of a target application executed by the resource using a second ML service;
generating, using the instructions, a profile recommendation for the target application according to the determined resource performance features and the application performance features; and
adjusting, using the instructions, one or more settings of the resource to optimize a performance of the target application executed by the resource.

12. The method of claim 11, further comprising generating the profile recommendation by combining the resource performance features with the application performance features using a ML hinting technique.

13. The method of claim 11, further comprising executing the first ML service separately and distinctly from how the second ML service is executed.

14. The method of claim 11, further comprising adjusting the settings of the resource only when a loading of the resource exceeds a specified threshold level.

15. The method of claim 11, further comprising optimizing the target application by adjusting at least one of a power operating level of the processor, a level of overclocking of the processor, or a level of underclocking of the processor, wherein the resource comprises the processor.

6. The method of claim 11, further comprising optimizing the target application by adjusting at least one of a frame rate, a refresh rate, or a computational frame rate of the GPU, wherein the resource comprises a graphics processing unit (GPU) of the IHS.

17. The method of claim 11, further comprising optimizing the target application by adjusting at least one of a write optimized setting, a read optimized setting, or a cache level of the storage device, wherein the resource comprises a storage device of the IHS.

18. The method of claim 11, further comprising optimizing the target application by adjusting a priority of the other applications executed on the resource, wherein the resource performance feature comprises one or more other applications that affect the loading of the resource.

19. The method of claim 11, further comprising optimizing the target application by adjusting a setting of the resource according to the detected operation, wherein the application performance feature comprises detecting a particular operation performed by the target application.

20. A memory storage device having program instructions stored thereon that, upon execution by one or more processors of an Information Handling System (IHS), cause the IHS to:
determine one or more resource performance features of a resource used by the IHS using a first machine learning (ML) service;
determine one or more application performance features of a target application executed by the resource using a second ML service;
generate a profile recommendation for the target application according to the determined resource performance features and the application performance features; and
adjust one or more settings of the resource to optimize a performance of the target application executed by the resource.
